(19) United States
(12) Patent Application Publication
(10) Pub. No.: US 2009/0302999 A1
(43) Pub. Date: Dec. 10, 2009

(54) SECURITY AND MONITORING CONTROL SYSTEM METHODS FOR VEHICLES

(75) Inventor: Richard J. Skertic, Carmel, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(73) Assignee: Anzen Electronics LLC, Carmel, IN (US)

(21) Appl. No.: 12/478,257

(22) Filed: Jun. 4, 2009

Related U.S. Application Data
(60) Provisional application No. 61/059,263, filed on Jun. 5, 2008.

(51) Int. Cl. G05B 19/00; G08C 19/00

(52) U.S. Cl. 340/5.64; 340/5.6; 340/5.85; 340/5.72

(57) ABSTRACT

A vehicle security and monitoring control system having one or more vehicle security and monitoring control (VSMCM) controllers, one or more wireless remotes and one or more base stations connected to a computer. The VSMCM controller prevents operation of a vehicle in a safe manner by requesting protected state configuration changes within the control module within the vehicle when prompted to disable the vehicle, and changes the protected state configuration back to the original state within the control module when prompted to enable the vehicle. The wireless remote prompts the VSMCM controller to lock doors, unlock doors, enable vehicle operation or disable vehicle operation of the control module within the vehicle. The base station communicates with the VSMCM controllers to update and change operation of the controllers, as well as record events and vehicle information taken by the controllers.

### CROSS-REFERENCE TO RELATED APPLICATIONS

This application claims the benefit of U.S. Provisional Application No. 61/059,263 filed Jun. 5, 2008, which is hereby incorporated by reference.

### BACKGROUND OF THE INVENTION

1) Field of the Invention

This invention relates to the Security and monitoring of data events of a vehicle and more particularly, to new vehicles located on a Dealership site.

2) Description of Related Art

Vehicles typically have some form of security to allow only the person with the key to operate the vehicle. For the new car Dealer, managing the inventory of new vehicles in such a way as to control the access to that vehicle has shown to produce efficiencies in sales, inventory maintenance and control over that inventory.

The state of the art is to help reduce the inefficiencies by managing the vehicle keys with a key management system. A further refinement of that approach is to place lockboxes on the vehicle. These lockboxes hold the keys to that vehicle so that the sales person does not need to leave the customer and can still show the vehicle.

The disadvantage of these systems are that the keys are located in a place that any non-salesperson can get to if they so desired. With the key management system the salesperson needs to go get the keys that are related to the vehicle that the customer wants to see. The salesperson might have to leave the customer many times and the keys are not guaranteed to be the correct keys or be there at all. Keys can be switched during the showing of the vehicle or copied. As for the Lockbox approach, just the fact that it is located with the vehicle outside of the dealership building is a signal to people that the keys for this vehicle are located with the vehicle without any supervision.

Neither of these systems manages nor controls the vehicle, just the keys. Neither method can guarantee that the vehicle is locked (secured) at closing, still on the dealership parking lot nor check the vehicle maintenance for trouble.

Vehicle technology is exponentially increasing in complexity and the human factor becoming to devious to trust. Thus, the desire for performing sales functions, maintenance functions and security functions are still valid. Improved or alternative methods are needed to be incorporated to guarantee the vehicle security, and its maintenance while increasing the efficiency of the sales force.

### BRIEF SUMMARY OF THE INVENTION

This invention relates to vehicle security and monitoring control systems, and more specifically to vehicle security and monitoring control systems that interfaces with control modules within vehicles to prevent theft or misuse of the vehicles as well as monitoring events of the sales person assigned a wireless remote.

Securing vehicles on vehicle dealership parking lots from theft and misuse is a very important concern for vehicle dealership owners. Vehicles are stolen from dealership parking lots or used without authorization, causing the cost of carrying insurance against these activities to rise due to frequent insurance claim filings.

There are many security systems in the prior art that address the security of a single vehicle using various methods and apparatus restricting access or preventing operation of a vehicle. Other systems in the prior art are designed to monitor the status and remote mobile location of vehicles within a fleet with respect to a base station. However, there still remains a need for systems and methods that address the security of a number of vehicles parked in a local area, such as a vehicle dealership parking lot. The present invention relates to security systems, monitoring events and methods of securing a number of vehicles in a local area that addresses many problems associated with the security of vehicles and the monitoring of events while on a dealership parking lot.

The present invention offers significant advantages over prior devices and methods by providing, according to one aspect of the invention, a Vehicle Security and Monitoring Control Module (VSMCM) controller for preventing operation of a vehicle, as well as monitoring events induced from an external source such as the wireless remote. The VSMCM controller changes the controller modules protected state configuration within the vehicle when the VSMCM controller is prompted to disable the vehicle, and changes the controller modules protected state configuration within the vehicle back to the original state when the VSMCM controller is prompted to enable the vehicle.

According to an aspect of the present invention, a method of safely preventing operation of a vehicle by checking the status of a vehicle operating parameters to determine safe conditions for disabling the vehicle based upon status of the vehicle operating parameter. An protected “enable” state is altered within a control module within the vehicle from a first state to a second state when safe conditions are determined. Changing the protected “enable” state disables operation of the control module and the vehicle. The method resets the protected “enable” state within the control module within the vehicle from the second configuration back to the first original configuration, enabling operation of the control module and the vehicle. A wireless remote prompts the VSMCM controller causing an event to be recorded at the base station. A base station communicates with the VSMCM controller, changing operation of the VSMCM controller to selectively respond to wireless remote(s) and record information.

According to another aspect of the present invention, a VSMCM controller comprises a vehicle communications buss connector and a microcontroller connected to the vehicle communications buss connector. The microcontroller has protected “enable” algorithms for permitting state changes by the control module connected to a vehicle communications buss within a vehicle when the VSMCM controller is prompted to disable a vehicle, and for when the VSMCM controller is prompted to enable a vehicle.

According to a further aspect of the present invention, a method of preventing operation of the vehicle by requesting a change of the protected “enable” states within a control module within the vehicle from a first state to a second state, disabling operation of the control module and vehicle during selected periods of times by selected wireless remotes. The method is reversed by requesting a change from the protected “enable” states within the control module from the second state to the first state, enabling operation of the control module and the vehicle.

According to an even further aspect of the present invention, a method of detecting unauthorized operation of the vehicle during unauthorized periods of time by monitoring the vehicle communications buss and alerting the authorities.

According to another aspect of the present invention, a method of detecting the location of the vehicle that requires maintenances or is the desired by the customer to purchase the vehicle and the ability of the device to determine current inventory for reporting to the dealership, an insurance company or other entity requiring such information.

The objects and advantages of the present invention will be more apparent upon reading the following detailed description in conjunction with the accompanying drawings and illustrations.

### BRIEF DESCRIPTION OF THE SEVERAL VIEWS OF THE DRAWINGS

FIG. 1 illustrates components of the vehicle security and monitoring/control system.

FIG. 2 illustrates an installed vehicle security and monitoring/control module (VSMCM) controller.

FIG. 3 is a perspective view of an embodiment of the vehicle security and monitoring/control module (VSMCM) controller.

FIG. 4 is a block diagram of components of the vehicle security and monitoring/control module (VSMCM) controller.

FIG. 5 is a block diagram of components of the vehicle security system base station.

FIG. 6 is a block diagram of components of the wireless remote.

FIG. 7 is a flow chart of the vehicle security system operating process.

FIG. 8 is a flow chart of the monitor vehicle parameters process.

FIG. 9 is a flow chart of the qualify command process.

FIG. 10 is a flow chart of the change state process.

FIG. 11 is a flow chart of the check and confirm safe conditions process.

FIG. 12 is a flow chart of the change vehicle “enable” state.

FIG. 13 is a flow chart of wireless remote operation process.

FIG. 14 is a flow chart of the key off-on process.

FIG. 15 is a flow chart of the base station operation process.

FIG. 16 is a flow chart of the wireless remote operation process.

### DETAILED DESCRIPTION OF THE PREFERRED EMBODIMENTS/INVENTION

For the purpose of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device and such further applications of the principles of the invention as illustrated therein being contemplated as would normally occur to one skilled in the art to which the invention relates.

A preferred embodiment of the present invention provides a vehicle security and monitoring control system having a plurality of uniquely identifiable vehicle security and monitoring control module (VSMCM) controllers that are interfaced with control modules in the vehicle, such as the engine control module, powertrain control module, vehicle control module or body control module, within vehicles parked in a local area to restrict access and/or prevent operation of the vehicles while monitoring events and/or activities of the sales person. The VSMCM controllers may be configured and wirelessly monitored by a remote base station and personal computer that records/logs events and communicates activities. The VSMCM controllers may request the “enable” state of the vehicle to change, disabling the modules and/or restrict access and/or prevent operation of the vehicle, even in the absence of the VSMCM controllers. Alteration of a vehicle state may be accomplished by requesting a protected state change in the vehicle controller module through a message requesting the state once the “enable” security key has been sent thus disabling operation of the module.

The module controllers may be prompted to operate with a number of uniquely identifiable wireless remotes that are configured to operate within certain parameters, restricting access and allowing operation of vehicles only when authorized. One application of the wireless remote configuration is to disable operation of the wireless remotes after normal business hours preventing unauthorized use, or completely disabling a wireless remote after loss or theft.

A preferred application of the present system is in the context of a vehicle dealership parking lot where a number of vehicles are parked within a relatively small area. Each vehicle in the dealership's inventory may be fitted with a VSMCM controller to prevent misuse or theft. Dealership employees may be issued a wireless remote that prompts the VSMCM controllers to lock and unlock vehicle doors as well as enable and disable the vehicles. Vehicle security and monitoring control system software running on a personal computer may be used to initialize the module controllers and wireless remotes and set system operating parameters. The remote base station is used to allow the personal computer to communicate with the VSMCM controllers once installed. The controllers can be configured to respond to dealership employee operation of the wireless remote based upon authority of the dealership employee to have access to the vehicle. For example, access may be restricted to a particular type or group of vehicles, or access may be restricted to permit operation of the controllers only during normal business hours.

The vehicle security and monitoring control system may also be used in conjunction with databases maintained by the vehicle dealership, holding information about vehicles parked on the dealership lot, to analyze trends based upon events/activities reported by the VSMCM controllers.

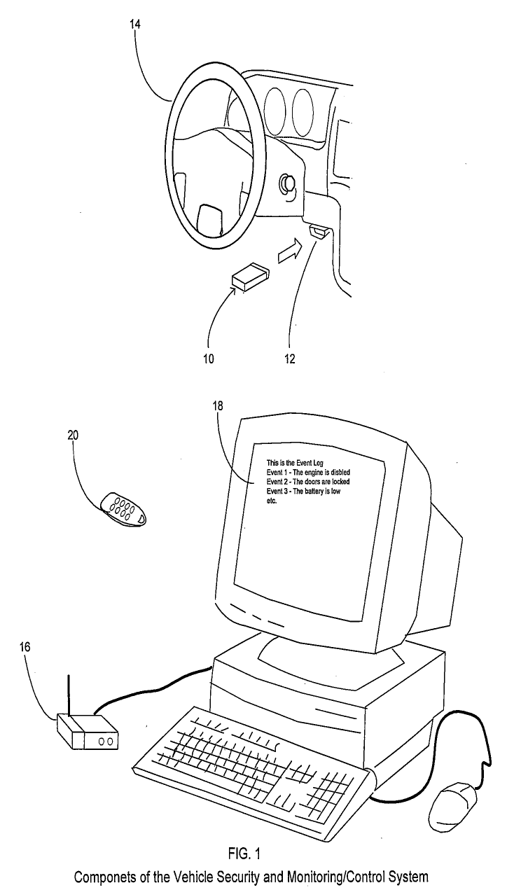

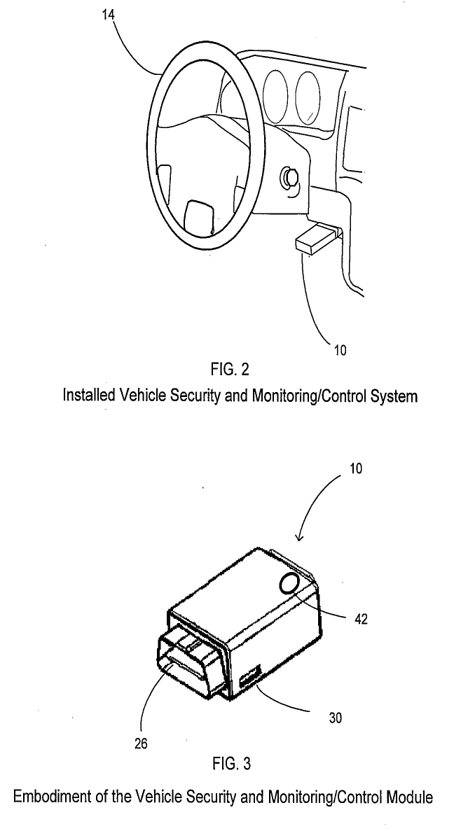

The vehicle security system, shown in FIG. 1, generally comprises of one VSMCM controller (10) for connection to a communications buss (12) within each vehicle (14) monitored and secured by the system. FIG. 2 shows connection/installation of a VSMCM controller (10) to the communications buss (12) within a vehicle (14). A remote base station (16), connected to a personal computer (18) running security and monitoring control system software, monitors and communicates with each of the VSMCM controllers (10). Authorized personnel are assigned a wireless remotes (20) and use them to prompt the VSMCM controllers (10) to lock and unlock vehicle doors as well as enable and disable operation of the vehicles (14). The remote base station (16) is used to initialize each VSMCM controller (10) and wireless remote (20) prior to use in the vehicle security and monitoring control system.

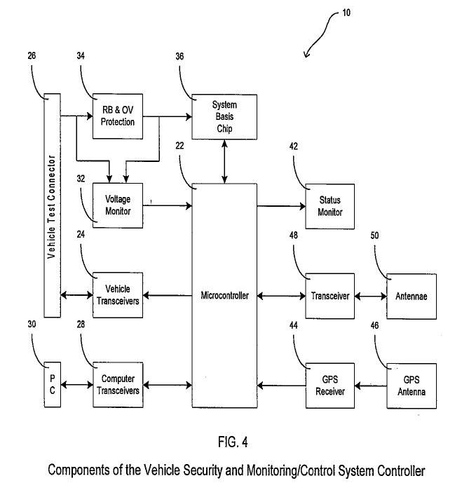

The hardware of the VSMCM controller (10), shown in FIG. 4, generally comprises a microcontroller (22), a vehicle transceiver (24) with vehicle test connector (26), a computer transceiver (28) with computer port connector (30), a voltage monitor (32) and over voltage protection (34), a system basis chip (36), a status monitor (42), a Global Positioning System (GPS) receiver (44) with antenna (46), and a transceiver (48) with antenna (50). FIG. 3 shows an embodiment of the VSMCM controller (10) with the vehicle test connector (26), computer port connector (30) and status monitor (42).

The microcontroller (22) has embedded software that implements security protocols, “enable” protocols, algorithms, programs and data structures to carry out the vehicle security and monitoring control system operating process, as shown in FIG. 7. An example of the type of microcontroller that may be used in the VSMCM controller (10) is the Motorola 9S12 series of microcontrollers. However, other microcontrollers having similar basic parameters may be used. The microcontroller (22) schedules messages to be communicated to the remote base station (16) and transmits events that log actions taken by the microcontroller (22) to the base station (16). Each microcontroller stores in memory a uniquely identifiable code comprised of the dealership Identity (ID) and the Vehicle Identification Number (VIN), that allows each VSMCM controller to be identified by the remote base station (16) and may store a list of wireless remotes (20) that are authorized to have access to the vehicle (14) through the VSMCM controller (10). The microcontroller (22) also operates a lock counter that functions to lock the vehicle doors after a preset count has lapsed to ensure that the vehicle doors are not inadvertently left unlocked for long periods of time.

The vehicle transceiver (24) includes a byte data link controller that translates signal protocols utilized by the microcontroller (22) to signal protocols utilized by control modules within vehicles, such as Society of Automotive Engineers (SAE) standard SAE Specification—Class B Data Communications Network Interface (J1850) communications protocol, Keyword 2000 signal protocol, Controller Area Network (CAN) signal protocol, or K-Line signal protocol, by way of the vehicle test connector (26), preferably an SAE Specification—Diagnostic Connector (J1962) connector that is compatible with all OEM vehicles made since 1996.

The computer transceiver (28) converts digital signals sent from the microcontroller (22) into serial protocol, RS232 protocol, USB protocol, or other protocols to communicate with a personal computer connected to port connector (30), preferably an RJ45 connector, or other standard SMT type connector.

The voltage monitor (32) with reverse battery and over voltage protection (34) protects the VSMCM controller (10) from transient voltage spikes and notifies the microcontroller (22) if the voltage received from the vehicle's battery is out of preset limits. The system basis chip (36) interfaces with the voltage monitor to regulate voltage supplied to the microcontroller (22). When the VSMCM controller (10) utilizes the Motorola 9S12 series of microcontrollers, voltage is supplied to the microcontroller (10) at approximately 5 volts. The system basis chip (36) also resets the microcontroller (22) if the microcontroller (22) does not carry out a process within a preset period of clock cycles to ensure that the microcontroller (22) operates properly.

The status monitor (42), preferably an LED, provides a visual means of communicating status of the VSMCM controller (10) and the vehicle (14) by communicating preset flash codes to indicate the condition of the VSMCM controller (10) or vehicle (14). The monitor status (42) is preferably communicated to the wireless remote to be displayed on the wireless remote display (79).

The GPS receiver (44) and antenna (46) communicates with the base station (16) to notify the base station (16) where the VSMCM controller (10) is physically located, enabling tracking and/or additional monitoring of the VSMCM controller (10) and/or the vehicle (14) that has the VSMCM controller (10) connected within the vehicle (14).

The transceiver (48) and antenna (50) allows the microcontroller (22) to communicate with the wireless remote (20) and the personal computer (18) by way of the base station (16). The transceiver (48) communicates with the wireless remote (20) and the remote base station (16) over commercial radio bands.

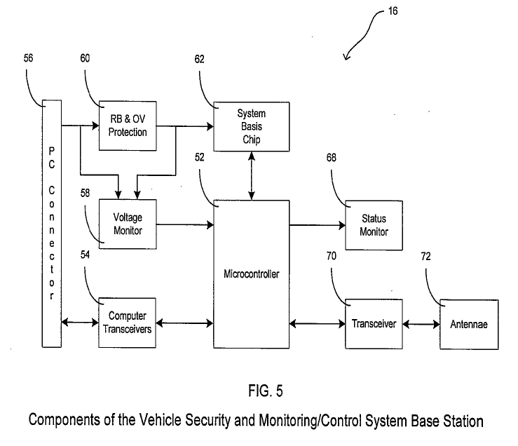

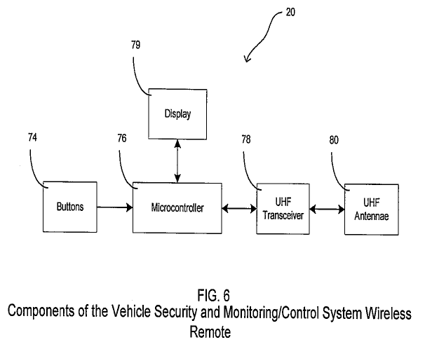

The hardware of the remote base station (16) is similar to that of the VSMCM controller (10). The hardware of the remote base station (16), shown in FIG. 5, generally comprises a microcontroller (52), computer transceiver (54) with serial port connector (56), a voltage monitor (58) with reverse battery and over voltage protection (60), a system basis chip (62), a status monitor (68), and a transceiver (70) with antenna (72). The remote base station (16) acts as the interface between the microcontroller (22) of the VSMCM controller (10) and the personal computer (18).

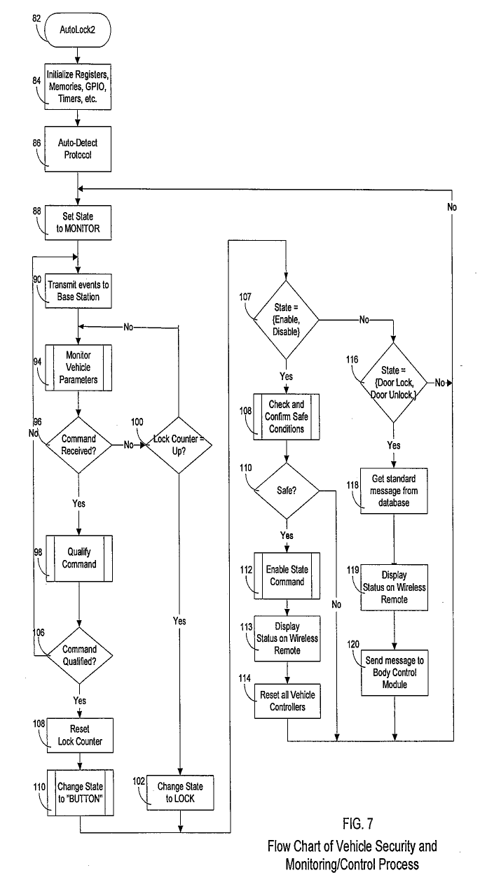

The hardware of the wireless remote (also commonly referred to as a FOB) (20), shown in FIG. 6, generally comprises buttons (74) interfacing with a microcontroller (76), a display device (79) preferably an LCD, and a transceiver (78) with antenna (80). An example of the type of microcontroller that may be used in the wireless remote (20) is the Motorola 9S08 series of microcontrollers. However, other microcontrollers having similar basic parameters may be used. The wireless remote (74) include enable and disable buttons used to prompt operation of the vehicle security system, as well as traditional wireless remote function buttons, such as lock and unlock vehicle doors, zero-nine, add, subtract, multiple, divide, equal, clear and on/off buttons, and has a calculator mode button. One embodiment of the present invention utilizes a wireless remote (20) having a zero through nine number keypad (not shown) that allows a user to enter a code, preferably the vehicle identification number (VIN) code, that uniquely identifies the particular VSMCM controller (10) that is desired to be associated with and operated. Another embodiment of the present invention relies upon the base station (16) to update a list of wireless remotes that are authorized to have access to the vehicles through the VSMCM controller (10), as described above. Each wireless remote (20) has an identification number comprised of an ID and the dealership ID that is programmed into the microcontroller (76) when manufactured that uniquely identifies each wireless remote (20) and its associated dealership. This identification number may be added to a list as a permission code that is held in the microcontroller (22), allowing only wireless remotes having identification numbers that match the permission codes on the list to operate the controller (10).

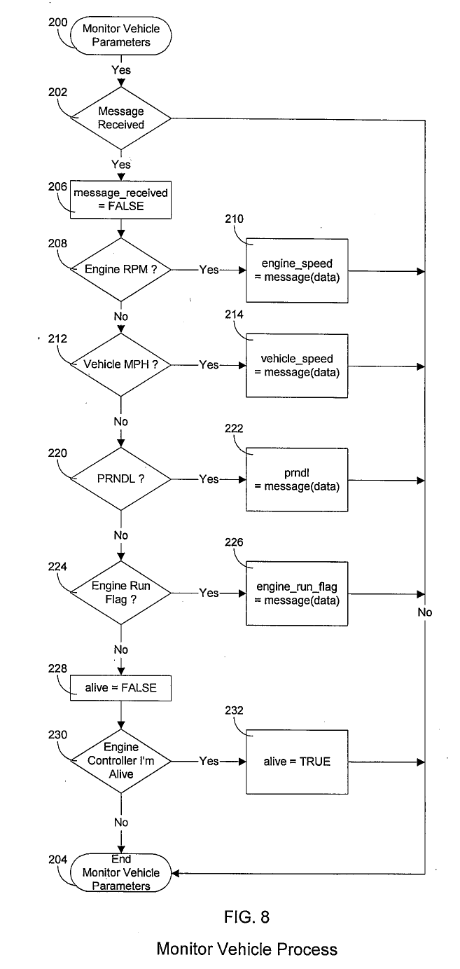

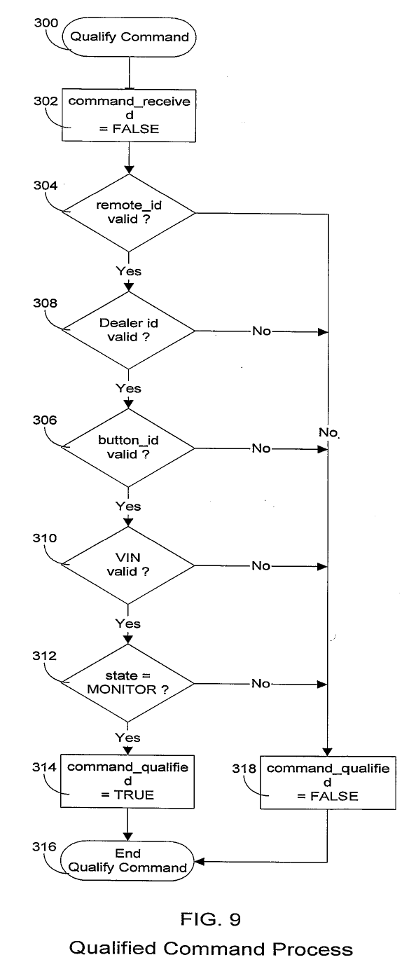

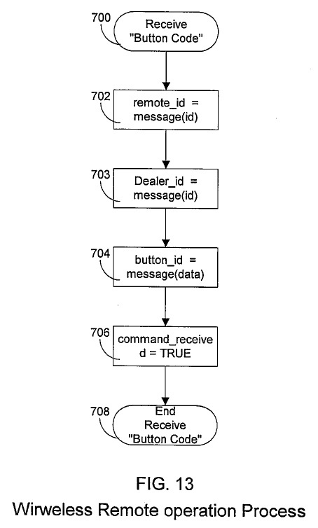

The VSMCM controller generally operates according to the process shown in FIG. 7. Upon initial start up of the process (82), the system is initialized (84) from the database and the communications protocol is auto detected (86). The state of the system is then set to Monitor (88) and the event is transmitted back to the base station (16) where the event is time stamped with the time (90) from the clock in the Personal Computer (PC) (30) and recorded/logged. The lock counter is then periodically updated (92) and the monitor vehicle parameters process (94) is initiated, as shown in FIG. 8 and described below. If an interrupt command (96) is received from a wireless remote (20) by way of the receive button code process, as shown in FIG. 13 and described further below, the qualify command process (98) is initiated, as shown in FIG. 9 and described further below. If an interrupt command (96) is not received from the wireless remote (20), the elapsed count value held in the lock counter is compared to a preset locking constant count value (100). If the elapsed count value held in the lock counter is equal to the preset locking constant count value, the state of the system is changed to Lock (102) and the VSMCM controller (10) communicates this by way of the vehicle test connector (26) through the communications buss (12) with control modules of the vehicle (14) to lock the vehicle doors. If the elapsed count value held in the lock counter is greater than the preset locking constant count value (104), the monitor vehicle parameters process (94) continues, such that the elapsed count value updated in the lock counter does not increment further past the value of the preset locking constant count value. If the elapsed count value held in the lock counter is not greater than the preset constant locking count value, the lock counter is updated by incrementing the elapsed count value (92).

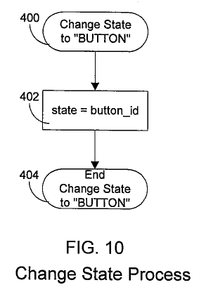

Upon receipt of an interrupt command (96) from the receive button code process, shown in FIG. 13, and a qualify command (106) from the qualify command process (98), the elapsed count value held in the lock counter is reset (108). If a qualify command (106) is not received from the qualify command process (98), the process is looped back to record/log the event and the time of the event (90) at the PC (30). If the elapsed count value held in the lock counter is reset (108) as a result of receiving a qualified command from the qualify command process (98), the state of the system is changed according to the change state to button process (110), as shown in FIG. 10 and described further below.

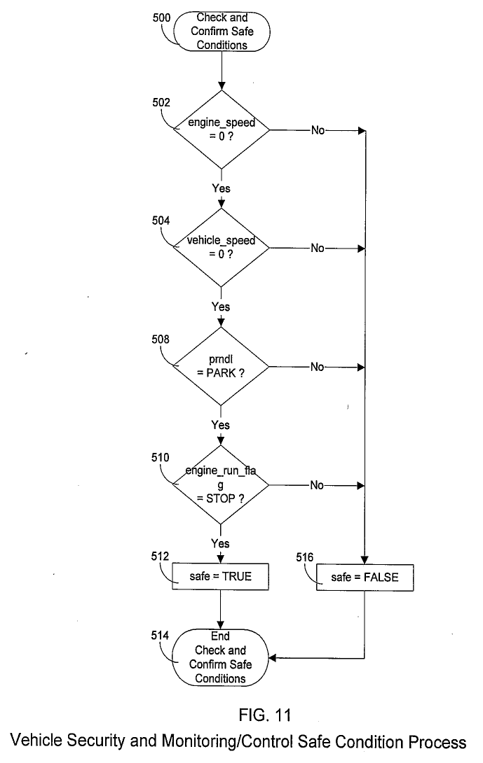

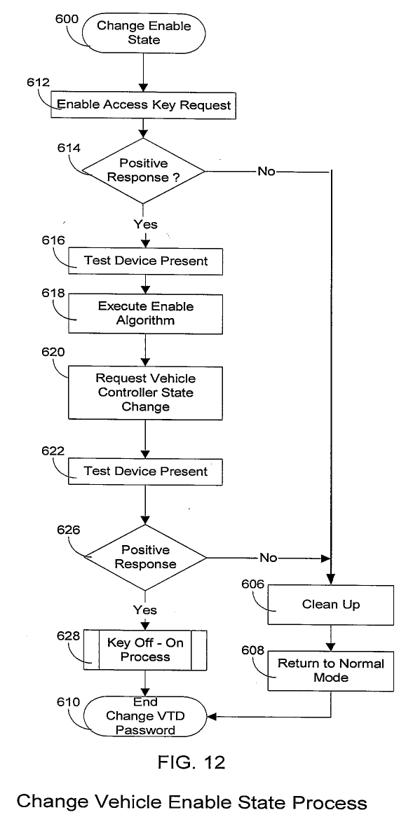

If the enable button or disable button of the wireless remote (20) is actuated to send the interrupt command (96), the change state to button process (110) changes the state of the system to the corresponding button. If the state is changed to enable or disable (107), the check and confirm safe conditions process (108) is initiated, as shown in FIG. 11 and described further below. If the check and confirm safe conditions process (108) indicates that safe is not equal to true (110), the process is looped back to setting the state of the system to monitor (88), as previously described above. If the check and confirm safe conditions process (108) indicates that safe is equal to true (110), the change vehicle enable state process (112) is initiated, as shown in FIG. 12 and described further below, and the control modules in the vehicle (14) is reset (114) upon placing the vehicle ignition in the off position with the vehicle key.

If the lock door, unlock door, button of the wireless remote (20) is actuated to send an interrupt command (96) from the receive button code process shown in FIG. 13, the change state to button process (110) changes the state of the system to the corresponding button. If the state is changed to lock doors, or unlock doors (116), a standard message from the vehicle database is retrieved (118) and sent to the body control module (120) to perform the desired function.

The previously mentioned monitor vehicle parameter process (94), shown in FIG. 8, is initiated (200) to check if a message that sets the message received flag to true is received (202) on the vehicle communications buss (12). If a message is not received (202), the monitor vehicle parameters process (94) is ended (204) and the command received (96) determination is made. If a message is received (202), the message received flag is set equal to false (206) and the received message identifier is checked for engine rpm (208). If the message is engine rpm engine speed data (210) is updated in the microcontroller (22). If the message identifier is not engine speed, the received message identifier is checked for vehicle mph (212). If the message is vehicle mph vehicle speed data (214) is updated in the microcontroller (22). If the message identifier is not vehicle speed, the received message identifier is checked for transmission selector position (220). If the message is transmission selector position, transmission selector position data (222) is updated in the microcontroller (22). If the message identifier is not transmission selector position, the received message identifier is checked for engine run flag status (224). If the received message indicates engine run flag status, engine run flag data (226) is updated in the microcontroller (22). If the message identifier is not engine run flag status, the engine control module alive flag (228) in the VSMCM controller is set to false. Next, the received message identifier is checked to determine if the message from the engine control module is a “Keep Alive” message (230). If the engine control module is operating in normal mode, then the engine control module alive flag (232) is set to true.

The previously mentioned qualify command process (98), shown in FIG. 9, is initiated (300) by setting the command received equal to false (302). If the wireless remote identification is valid (304), button identification is valid (306), dealer identification is valid (308), vehicle identification number is valid (310), and the state is equal to monitor (312), then the command is qualified and the associated flag is set to equal true (314) and the qualify command process (98) is ended (318). If any of the remote identification (304), button identification (306), Dealer identification (308), or vehicle identification number (310) are not valid, or if the state is not equal to monitor (312), the command is not qualified and the associated flag is set to equal false (318).

The previously mentioned change state to button process (110), shown in FIG. 10, is initiated (400) when a button (74) is actuated on the wireless remote (20). When the microcontroller (22) receives the button state information by way of the transceiver (48) and antenna (50), the state of the system is changed to equal the button identification (402), such as to equal enable, disable, lock doors, or unlock doors, before ending the process (404).

The previously mentioned check and confirm safe conditions process (108), shown in FIG. 11, is initiated (500) if the enable button or disable button (74) of the wireless remote (20) is actuated. The check and confirm safe conditions process (108) looks at the data provided by live control modules in the previously mentioned monitor vehicle parameter process (94) to confirm that the engine speed is zero (502), vehicle speed is zero (504), that the transmission is in park (508) and the engine run flag is set to stop (510), before setting safe equal to true (512) and ending the process (514). If any of these parameters are not correct, safe is set equal to false (516) and the change vehicle enable state process (112) is not initiated.

The previously mentioned change vehicle enable state process (112), shown in FIG. 12, is initiated (600) by examining the monitor vehicle parameters process (94) results. If the process results in an alive equals true (232) status, clean up (606) is initiated, normal message transmission is enabled (608) and the change vehicle enable state process (112) is ended (610). If the monitor vehicle parameters process (94) results is an alive equals false (228) status, then the enable state security access procedure (612) is initiated much like the SAE J2186 EE Data Link Security Specification except it does not allow access to the vehicle controller code, just access to the ability to change the “enable” state. If a positive response (614) is not received from a control module within the vehicle (14), clean up (606) is initiated and normal message transmission is enabled (608). If a positive response (614) which is the return of the enable seed is received from a control module within the vehicle (14), a message is sent to indicate the VSMCM controller (10) is present (616) on the communications buss (12) as a test device followed by the execution of an algorithm (618) using the enable seed, and the VIN to produce an enable key. An enable state change request (620) by the module controller (10) on the communications buss (12) is sent to the control module within the vehicle (14) with the enable state change key. Another message is sent to indicate the VSMCM controller (10) is present (622) on the communications buss (12) as a test device. If a negative response (626) is received from the request for “enable” state change (620), clean up (606) is initiated and normal message transmission (608) is enabled. If a positive response (626) is received from the request for “enable” state change (620), the “enable” state change is executed (620), and normal message transmission (608) is enabled.

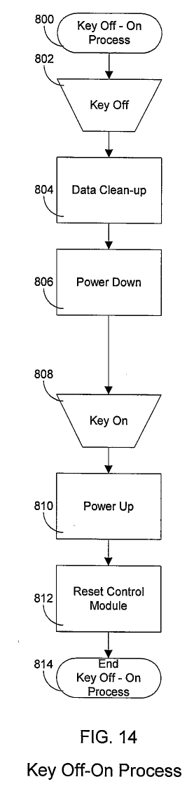

The enable state change key (620) sent from the microcontroller (22) to control modules in the vehicle (14), by way of the communications buss (12), changes protected states within one or more of the control modules disabling operation of the vehicle (14) itself. This effectively changes the internal protected state of the control module from an original first state configuration to an altered second state configuration. In other embodiments of the present invention, other parts of the control module may change to disable certain control modules and the vehicle (14) itself, effectively changing the “enable” state from an original first state configuration to an altered second state configuration. The ignition key off-on process (628), shown in FIG. 14 and described further below, finalizes the engine state change and ends (610) the change vehicle “enable” state change process (112).

The previously mentioned receive button code process, as shown in FIG. 13, is carried out when a button (74) of the wireless remote (20) is actuated and a radio frequency message is sent from the transceiver (78) and antenna (80) of the wireless remote (20) to the transceiver (48) and antenna (50) of the VSMCM controller (10). When initiated (700), the identity of the radio frequency message will be set equal (702) to the unique identification number of the wireless remote (20). Data within the radio frequency message will then be set equal (704) to the button (74) actuated on the wireless remote (20). A command received set equal to true status is set (706), ending the receive button code process (708) and initiating the qualify command process (96).

The previously mentioned ignition key off-on process (628), shown in FIG. 14, is initiated (800) when the vehicle key is used to turn the vehicle ignition system to an off position (802). When the key is turned off (802), the enable state change (112) activates, normal system data cleanup commences, normal system security is activated (804) and the VSMCM controller (10) is powered down (806) to conserve power. When the vehicle key is used to turn the vehicle ignition system to an on position (808), the VSMCM controller (10) is powered up (810) and the control module that received the enable state change message (620) is reset (812), ending the key off-on process (814). This process (812) effectively finalizes the state configuration of the control module to be the first or second state configuration, as previously described, when prompted to enable or disable, respectively.

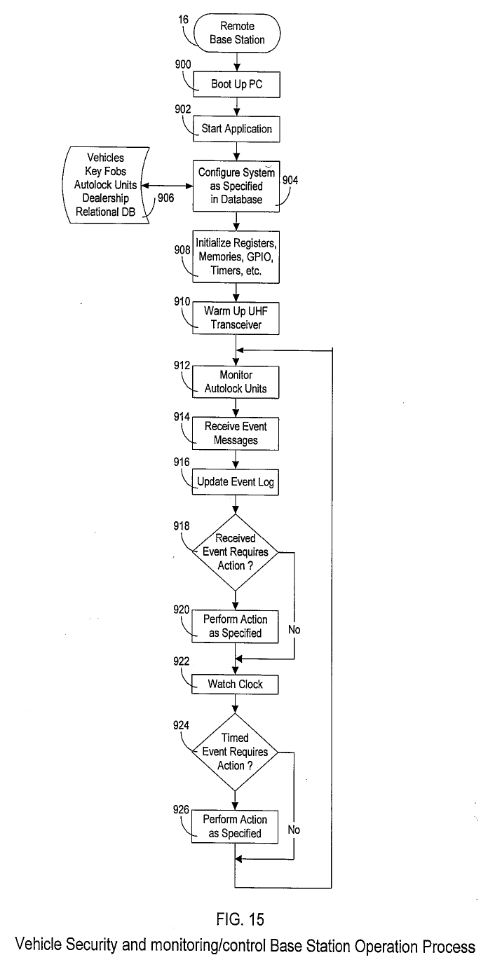

The remote base station (16) generally operates according to the process shown in FIG. 15. The base station process is initiated by booting up (900) the personal computer (18) connected to the remote base station (16), having application software installed for operating the base station (16). The software application is started (902) so that the wireless remotes (20) and VSMCM controllers (10) may be configured (904) with information from the dealership's relational database (906). Next, aspects of the system are initialized (908), the transceiver (72) is powered up (910), and the software application utilizes the remote base station (16) to monitor (912) the VSMCM controllers (10).

When the base station (16) receives an event message (914), the message is record/logged in the event log (916). If the received event message requires action (918), the action is performed (920). If the received event message does not require action (918), the application software and base unit (16) continue to watch (922) the real time clock in the PC (18) until a timed event requires action (924). When the timed event requires action (924), the action is performed (926) and the application software and base unit (16) continue to monitor the VSMCM controllers (10). While the base station (16) records/logs events, an event can be, but not limited to, actions taken by the VSMCM, as a result of a wireless remote assigned to a sales person, the base station or an external command, to change the condition of the vehicle as well as vehicle information collected by the VSMCM and stored in a vehicle log file on the personal computer for various reporting to the dealership.

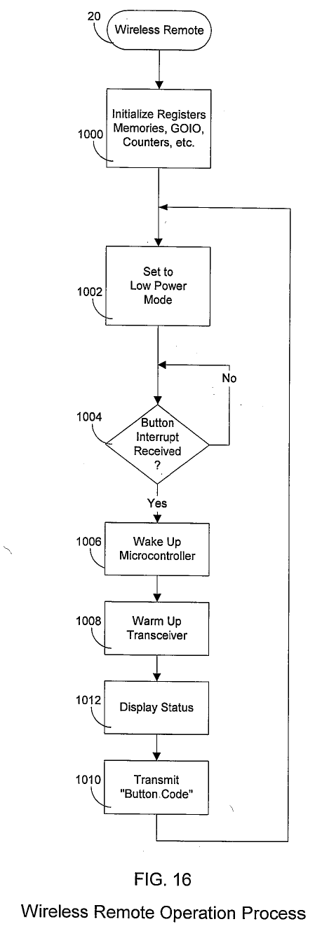

The wireless remote (20) generally operates according to the process shown in FIG. 16. When put into operation, aspects of the wireless remote (20) are initialized (1000), and the power setting is set to low (1002) until it receives a button interrupt signal (1004) when a button (74) is actuated on the wireless remote (20). Upon receipt of a button interrupt signal (1004), the microcontroller (76) is awakened (1006), the transceiver (78) is powered up (1008), and the button code is sent (1010) by way of the transceiver (78) and antenna (80). The type of information sent and received is displayed on the wireless remote displayed (79) as conformation of the event.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1. A method of preventing operation of a vehicle, comprising the acts of:
transmitting from an out-of vehicle transmitter a first signal to a controller that is within a vehicle;
in response to said first signal, changing the protected operating state configuration within a controller within said vehicle from a first state configuration to a second state configuration, disabling said vehicle via said controller;
wherein said changing said protected operating state includes changing computer program code of said controller from a first program code configuration to a second, disabled computer code configuration;
and, thereafter,
transmitting from an out-of vehicle transmitter a second signal to said controller that is within said vehicle;
in response to said second signal, resetting the protected operating state configuration within a controller within said vehicle from said second state configuration to said first state configuration, enabling the engine of said vehicle via said controller;
wherein said resetting said protected operating state includes changing computer program code of said controller from said second program code configuration to said first, enabled computer code configuration.

2. The method of claim 1, wherein said transmitted signals are to a removable module within the vehicle and with a communications buss connector for connection to a vehicle controller.

3. The method of claim 2, wherein the removable module further comprises a microcontroller connected to said communications buss connector, requesting protected state configuration changes to a vehicle controller when said removable module is signaled to disable and to enable.

4. The method of claim 3, wherein said vehicle remains in its requested protected state configuration even if said module is removed from the vehicle communications buss connector.

5. The method of claim 4, wherein requesting said enable state configuration comprises changing a security password in memory in said vehicle controller.

6. The method of claim 5, wherein said act of transmitting includes transmission from one of a plurality of wireless remote transmitters.

7. The method of claim 6, wherein said act of transmitting includes transmission from base station.

8. The method of claim 7, wherein said base station changes said operation of said controller according to one or more selected times.

9. The method of claim 8, wherein said base station changes said operation of said controller updating permission codes within said controller comprising identification of authorized one or more wireless remote transmitters.

10. The method of claim 9, and further comprising the acts of:
determining safe conditions for disabling said vehicle based upon safe conditions including one or more of: (a) the transmission being in park; (b) the engine not running; (c) the vehicle not moving;
changing the protected state configuration within a control module within said vehicle from a first state configuration to a second state configuration only when safe one or more of said conditions are determined, said change of said protected state configuration disabling said vehicle.

11. The method of claim 10, and further comprising a GPS device in said vehicle, and further comprising the act of transmitting location information thereof to said base station.

12. The method of claim 11, and further comprising the act of transmitting vehicle maintenance information to said base station.

13. The method of claim 12, and further comprising transmitting from said base station to set system operating parameters, whereby said base station communicates with a plurality of said controllers, and whereby said base station also communicates with a plurality of said wireless remotes, whereby selected said controllers are configured to respond to selected wireless remotes to provide access to one or more groups of vehicles being restricted to one or more corresponding groups of wireless remotes.

14. The method of claim 1, wherein said controller further comprises a microcontroller connected to said communications buss connector, requesting protected state configuration changes to said vehicle controller when said removable module is signaled to disable and to enable.

15. The method of claim 2, wherein said vehicle remains in its requested protected state configuration even if the module is removed from the vehicle communications buss connector.

16. The method of claim 1, wherein requesting said enable state configuration comprises changing a security password in memory in said vehicle controller.

17. The method of claim 1, wherein said act of transmitting includes transmission from one of a plurality of wireless remote transmitters.

18. The method of claim 1, wherein said act of transmitting includes transmission from base station.

19. The method of claim 18, wherein said base station changes said operation of said controller according to one or more selected times.

20. The method of claim 18, wherein said base station changes said operation of said controller updating permission codes within said controller comprising identification of authorized one or more wireless remote transmitters.

21. The method of claim 1, and further comprising the acts of:
determining safe conditions for disabling said vehicle based upon safe conditions including one or more of: (a) the transmission being in park; (b) the engine not running; (c) the vehicle not moving;
changing the protected state configuration within a control module within said vehicle from a first state configuration to a second state configuration only when safe one or more of said conditions are determined, said change of said protected state configuration disabling said vehicle.

22. The method of claim 1, and further comprising a GPS device in said vehicle, and further comprising the act of transmitting location information thereof to a base station.

23. The method of claim 1, and further comprising the act of transmitting vehicle maintenance information to a base station.

24. The method of claim 1, and further comprising transmitting from a base station to set system operating parameters, whereby said base station communicates with a plurality of said controllers, and whereby said base station also communicates with a plurality of said wireless remotes, whereby selected said controllers are configured to respond to selected wireless remotes to provide access to one or more groups of vehicles being restricted to one or more corresponding groups of wireless remotes.

25. A method of preventing operation of a vehicle, comprising the acts of:
transmitting a first signal to a controller that is within a vehicle;
in response to said first signal, changing the protected operating state configuration within a controller within said vehicle from a first state configuration to a second state configuration, disabling said vehicle via said controller;
wherein said first signal changes said operation of said controller according to one or more selected times;
and, thereafter,
transmitting a second signal to said controller that is within said vehicle;
in response to said second signal, resetting the protected operating state configuration within a controller within said vehicle from said second state configuration to said first state configuration, enabling the engine of said vehicle via said controller;
wherein said second signal changes said operation of said controller according to one or more selected times.

26. The method of claim 25, wherein said transmitted signals are to a removable module within the vehicle connected to a vehicle controller.

27. The method of claim 25, wherein said act of transmitting includes transmission from base station.

28. The method of claim 27, and further comprising transmitting from a base station to set system operating parameters, whereby said base station communicates with a plurality of said controllers, and whereby said base station also communicates with a plurality of said wireless remotes, whereby selected said controllers are configured to respond to selected wireless remotes to provide access to one or more groups of vehicles being restricted to one or more corresponding groups of wireless remotes.

29. The method of claim 25, and further comprising the acts of:
determining safe conditions for disabling said vehicle based upon safe conditions including one or more of: (a) the transmission being in park; (b) the engine not running; (c) the vehicle not moving;
changing the protected state configuration within a control module within said vehicle from a first state configuration to a second state configuration only when safe one or more of said conditions are determined, said change of said protected state configuration disabling said vehicle.

30. A system for preventing operation of a vehicle, comprising:
a plurality of out-of vehicle transmitters adapted for transmitting a first signal;
at least one controller is a vehicle, wherein in response to said first signal, said controller changes the protected operating state configuration within said controller from a first state configuration to a second state configuration, disabling said vehicle via said controller;
wherein said changing said protected operating state includes changing computer program code of said controller from a first program code configuration to a second, disabled computer code configuration;
wherein at least one of said plurality out-of vehicle transmitters is adapted to transmit a second signal to said controller;
wherein in response to said second signal, said controller resets the protected operating state configuration from said second state configuration to said first state configuration, enabling said vehicle to run via said controller;
wherein said resetting said protected operating state includes changing computer program code of said controller from said second program code configuration to said first, enabled computer code configuration.

31. The system of claim 30, and further comprising:
wherein said controller is adapted for determining safe conditions for disabling said vehicle based upon safe conditions including one or more of: (a) the transmission being in park; (b) the engine not running; (c) the vehicle not moving;
and wherein said controller changes protected state configuration from a first state configuration to a second state configuration only when safe one or more of said conditions are determined, said change of said protected state configuration disabling said vehicle.

32. The system of claim 30, and further comprising a plurality of vehicles with a corresponding plurality of controllers therein; a base station adapted for transmitting to set system operating parameters, whereby said base station communicates with said plurality of said controllers, and whereby said base station also communicates with a plurality of wireless remotes, whereby selected said controllers are configured to respond to selected wireless remotes to provide access to one or more groups of vehicles being restricted to one or more corresponding groups of wireless remotes.
